(19) United States
(12) Patent Application Publication
(10) Pub. No.: US 2012/0110976 A1
(43) Pub. Date: May 10, 2012

(54) Universal aero space , naval eternal technology systems

(76) Inventor: Marius Angelo Paul, Yorba Linda, CA (US)

(21) Appl. No.: 13/200,854

(22) Filed: Oct. 3, 2011

Related U.S. Application Data
(63) Continuation-in-part of application No. 13/134,696, filed on Jun. 14, 2011.
(60) Provisional application No. 61/456,508, filed on Nov. 8, 2010.

(51) Int. Cl. F03H 99/00

(52) U.S. Cl. 60/200.1

(57) ABSTRACT

The invention is a universal aero, naval and space, one class integrated technology, originated from a common, fundamental unique basic absolute maximum efficiency technology, total endothermic, hyperbaric, adiabatic and stoichiometric maximum power capacity, with unlimited pressure ratio, which is the unification of the way to produce a top absolute efficiency by cryogenic electrification of all the transportation systems from ground to the entire universe.

This invention is a continuation in part with our original patent application with the title:

“Absolute Universal Engine, One from Ground to Orbit,
application Ser. No. 13/134,696; Filling date; Jun. 14, 2011;
Domestic Priority data claimed of 61/458,508 of Nov. 8, 2010

### CONFIRMATION No. 8326 UPDATED FILLING RECEIPT Sep. 14, 2011

The invention is a universal integrated of one supreme class of aviation, naval, and space technology originated from a common, fundamental unique basic absolute maximum efficiency technology, total endothermic, hyperbaric, adiabatic and stoichiometric maximum power capacity, unlimited pressure ratio, which is the unification of the way to produce a top absolute maximum efficiency and cryogenic electrification for all the transportation system on the entire universe, by maximum absolute to unlimited altitude, and unlimited universal space range of action.

### BACKGROUND

Actual aviation, naval and space technologies are based on fundamental distinct and specific limited technologies resulted from their own historic origin, from the specific of their dominium of environments speed, altitude applications, and evolution, and using only petrol for all operation.

The specific differentiation based on specific technologies limitations, are the basic negative source for all their problems and incapacity to develop a future evolution, the total and drastic barrier of maximum turbine intake temperature at actual 1000-1200 C, maximum limiting temperature acceptable for the best available materials for the actual gas turbines, is imposing a very high air fuel ratios near 60/1, four time bigger than ideal stoichiometric 15/1 combustion for maximum absolute thermodynamic power, condemning the actual technology at ¼, from the maximum thermodynamic power potential.

Actual extreme low efficiency is the result of actual drastic temperature and pressure ratios basic limitation of their future and capabilities.

Today the most eloquent drastic temperature limitation, was demonstrated by the minor leak of oil in the gas turbine or Rolls Royce Trent 900, produced of explosion in flight of many gas turbines by the extreme high temperature and intense fire produced by this minor oil leak.

The next catastrophic limitation of temperature for flying in air at ultra high speed was the <<<HOT OUT and HOT IN, FALCON RAMJET DESINTEGRATION IN SECONDS>>>

All these are indications about the end of evolution of all the gas turbine, along the last century

The same gas turbine having a bypass ratio of 10/1, resulting that only 10% from the total area and air entering in the front of the engine is designated to enter in the core of the gas turbine to produce the power and the trust, of only 5/1 trust to weight ratio.

The final utilization of the air is 1/10×¼= 1/40 equivalent 2.5% from total air intake

### BRIEF DESCRIPTION OF THE INVENTION

The invention is based on a fundamental new concept of one endothermic, hyperbaric and adiabatic technology produced by one and/or a counter rotating group of self cooled endothermic recuperative integrated concentric in <<<one rotor gas turbine-fan-compressors>>> associated with common central combustion chamber, for activating the gas turbine and an associated coaxial variable geometry intake bypass, and variable geometry, combined gas turbojet, turbo rocket, turbo ramjet, from ground to space jet propulsion, with the maximum absolute capability to reach the maximum stoichiometric combustion, eliminating the actual total limitation of the temperature of the entire hot core, capable to reach maximum absolute compression and expansion ratios, and elimination of actual gas turbines drastic temperature limitation blocking totally today any new potential future evolution of the performances of actual gas turbines.

This invention is producing a new entire common central cooled endothermic, hyperbaric and adiabatic body of the new counter rotating gas turbine at maximum stoichiometric hyperbaric level, of endothermic adiabatic turbine, having 100% central core of the engine running cooled and transferring the recuperated cooling energy to the propulsion fluid at the lowest external atmospheric temperature, including the extreme cryogenic electric energy, incorporated in liquid oxygen, and hydrogen, recuperative heat returned totally to the propulsion jet, generating a maximum absolute power by stoichiometric combustion of all the air and or pure oxygen at maximum efficiency of Paul Carnot Thermal Endothermic and Adiabatic Cycle, with highest pressure ratio for compression and expansion producing absolute lowest exhaust temperature, at near zero infrared signature, equal with the intake external temperature, which is the definition of maximum absolute efficiency.

The invention is creating a universal unique supreme class of universal mobility vehicle, which can fly in air from ground to the universal limit of the space, from vertical taking off and vertical landing and standing in air, flying subsonic, supersonic, to unlimited speed, and the same engine and vehicle can be convertible for universal navigation over the sea by a new jet propulsion radical revolutionary new naval ship, can navigate with a new jet propulsion submarine, by self producing the eternal fuel oxygen and hydrogen, from an on board nuclear hyperbaric electric generator, electrolyzing the sea water in oxygen and hydrogen cryogenically stored the electrical nuclear energy for the production, and used for surfing again in air until to the end of the space with eternal unlimited range universal mobility.

By the supreme capability to self production on board and stored of liquid oxygen and hydrogen, by the operation on sea, or submarine electric nuclear power generation, is equivalent to transform all the aviation and naval operation in a <<<nuclear electrification general system>>> of the universal naval, aviation and space travel for eternal unlimited energy revolution.

Finally the production of liquid oxygen and hydrogen and energy, from wind, solar, hydraulic, and nuclear eternal energy, by electrolyzing the sea water, and any contaminated water, is the absolute way for eternity, for the liberation of the aviation, naval and space from petrol dependence.

The invention is creating a unique new class of vehicle with universal mobility with unlimited capability to start vertical from any place and fly and land to any place, forming a universal global and space aviation, without airports, totally stealth radar and zero infrared signatures, having the capability for replacing all actual old and low efficient engines, by these new ultra simple, lowest cost and highest maximum absolute efficiency new gas turbines

The invention can generate a new class of unique supreme mobility vehicles for naval aviation, with bigger, longer and larger vehicles than ship transversal size, and actual general ships, by these new vehicles without <<<wings and tails>>> capable to start vertically instantly all the airplanes from any surface ships or from under sea submarines and using oxygen and hydrogen produced by the fleet, and aircraft carriers, and landing vertical back without running on the surface of the runaway, with unlimited global and universal range, manned and unmanned operation, or returning over the sea surface, or even under submarine continuous operation.

This invention of these new gas turbines with new jet propulsion in air, naval and space of all aero, naval surface and submarine vehicles can raise the speed of navigation to unimaginable actual level, by unlimited freedom to navigate in all types of condition with unlimited capability to alternate operation from any mediums, to any mediums, with variable speed and operability.

This invention of this new class of gas turbines with absolute maximum efficiency is the ideal replacement for all engines for space missions and for all actual vehicles, aero, naval and space conventional military and commercial aviation condemned with actual low efficiency and limited capabilities.

This invention is creating a universal convertible new class of unique hyperbaric, stoichiometric, endothermic, adiabatic engines with common structural base and capability, for universal convertible, universal mobility, turbo fan subsonic, turbojet supersonic, turbo ram jet ultra sonic, turbo rocket from ground, and for unlimited universal mobility operation from ground and sea to space to the end of the universe.

The final extremely important application of this invention, is creating a fundamental new class of revolutionary vehicles for actual fire fighters, which are actually totally unable to act at the highest level of fire in the actual tall buildings, by this invention is creating the new class of universal mobility vehicles, with capability for vertical instant take off, and climbing to the highest level of tall buildings with unique ability to touch the face of the building, saving all the peoples, and attacking the base of the fire directly, instantly and totally, from ground to the top, by transporting all the anti fire materials on the place of the fire, and saving all the people from fire.

This unique invention is the total protection against of fire of all high buildings, and all big cities actually virtually unprotected and ideal target of terrorism, with unlimited tragic demonstrated vulnerability.

### BRIEF DESCRIPTION OF PREFERRED EMBODIMENT BY THE FOLLOWING FIGURES

FIG. 1 the <<<ONE INTEGRATED>>> Turbo Fan, Turbo Compressor, with Concentric Peripheral Gas Turbine, self endothermic and adiabatic.

FIG. 2 the One Turbo Integrated endothermic and adiabatic Ram Rocket

FIG. 3 the One Integrated Two Turbo endothermic adiabatic Ram Rocket

FIG. 4 the One Integrated Three Turbo endothermic adiabatic Ram Rocket

FIG. 5 the Universal Mobility endothermic adiabatic Turbojet Rocket

FIG. 6 the Universal Mobility Convertible endothermic, adiabatic Turbo Fan-Air, Turbojet, Turbo Rocket

FIG. 7 the Universal Mobility Convertible endothermic, adiabatic Turbo Fan, Turbojet, Turbo Rocket

FIG. 8 the Universal Mobility Convertible Transitional endothermic, adiabatic, Turbo Fan, Total Turbojet, Turbo Rocket

FIG. 9 the Universal Mobility Convertible, Two Turbojet endothermic, adiabatic, Turbo Fan, Turbo Rocket

FIG. 10 the Universal Convertible Variable By-Pass, endothermic and adiabatic Two Turbojets, Ramjet, Turbo Rocket

FIG. 11 the Universal Mobility Wingless, Tailless with Two Universal Aero Space Engines

FIG. 12 the Universal Mobility Wingless Tailless Convertible, endothermic, hyperbaric, adiabatic, Multi Turbojet, Ramjet, Turbo Rocket.

FIG. 13 the Universal Convertible Mobility Air and Space Vehicle

FIG. 14 the Universal Mobility Wingless-Tailless, endothermic, hyperbaric, adiabatic, Two Turbojet, Turbo Rockets, on General Naval and Air Craft Carriers Operation.

FIG. 15 the Universal Mobility Fire Fighter Wingless-Tailless, Multiple endothermic, hyperbaric, adiabatic, Turbojets, Turbo Rockets,

FIG. 16 the Universal Paul-Carnot, Endothermic, Hyperbaric, Stoichiometric, Adiabatic Cycle

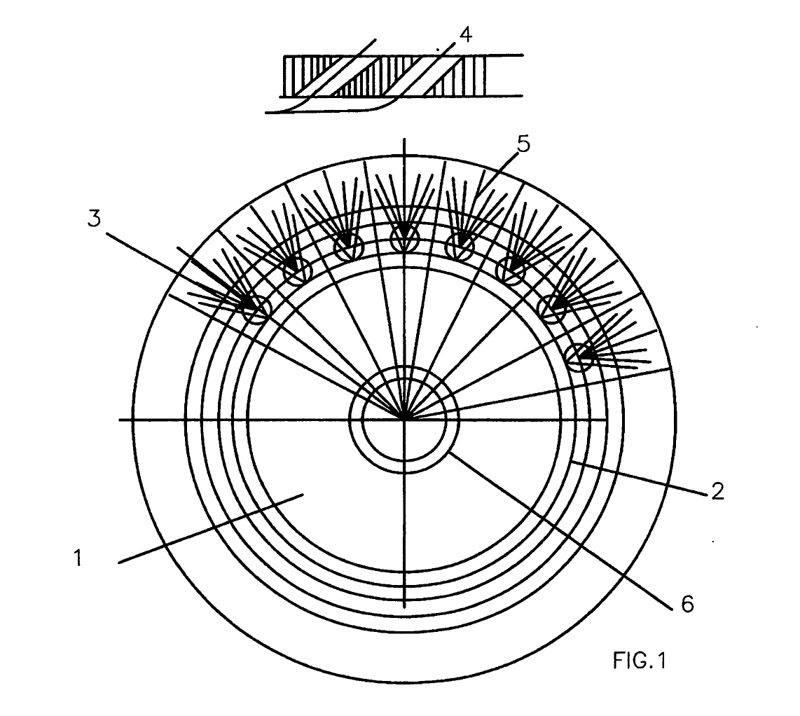

In the FIG. 1, based on our original patent application of <<<Absolute universal engine, One from the Ground to Orbit>>> resulted a large family of engines based on the same fundamental unique <<<ONE INTEGRATED>>> Turbo Fan, Turbo Compressor, Concentric Peripheral Gas Turbine.

This new patented technology is extending the field of conceptual new application to a new 15 and potential unlimited multiple applications, which are culminating with the maximum absolute of the top definition of the absolute PAUL-CARNOT Endothermic, Hyperbaric, Stoichiometric, Adiabatic cycle, with maximum absolute efficiency of thermodynamics, for universal aviation, new jet naval propulsion on surface, submarine, universal aircraft carriers for universal mobility vehicles, to the end of space unlimited universal dimensions.

The composition of this concept <<<ONE INTEGRATED>>> endothermic, hyperbaric, stoichiometric adiabatic is the fundamental base for all these application, and is made from a central fan-compressor disk rotor 1, surrounded by a ducted crown 2, of a concentric gas turbine air and/or cryogenic endothermic cooling roots 3, provided by a self axial pumping air/fluid cooling blades roots 4, conducting the cooling air/fluid, inside the gas turbine blades 5, from which an air/fluid film, and internal injected fuel homogenous mixture is forming a cooling fluid, generated inside the turbine blades, which will emerge outside of the surface of the gas turbine blades, through micro holes, which are producing an air/fluid transpiration by external humid fuel-air film over the surface of the blades, forming a thermal self generating protective isolation barrier for cooling, and external protection of the gas turbine blades, from the direct contact with the hot gases, forming an intensive internal and external cooling, combined with an inter stage isothermal combustion.

The biggest physical mass of the central core of the fan compressor is forming a maximum sink heat absorber, endothermic cooling the concentric crown of the gas turbine blades, by heat conduction, convection and heat recovery transferred to the central air flow energizing the propulsion.

This invention is generating a unique new generation of gas turbines with endothermic cooled central core, which is the absolute major revolution in the history of world gas turbines producing an absolute maximum secure protection of all aviation in the world, and eliminating the temperature barrier for maximization of the efficiency, and power density to the capacity to have a stoichiometric total combustion. The complete rotor is free rotating and centered on the tubular strong hub bearing 6.

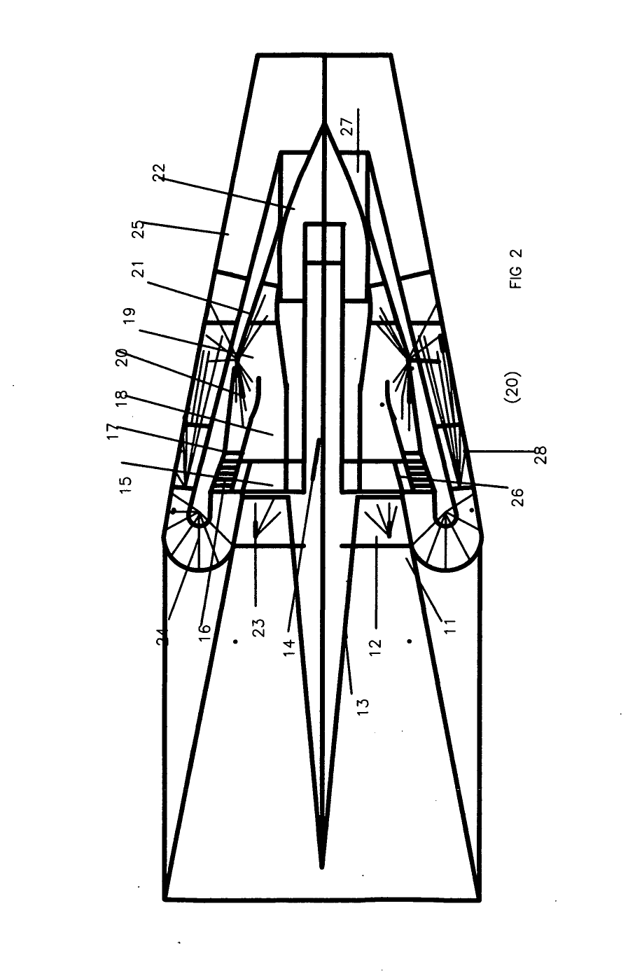

In The FIG. 2 is depicted The One Integrated endothermic, hyperbaric, adiabatic, stoichiometric, Turbo Ram, Turbo Rocket, composed and indicated by a generic number (20), having a body 11, with the intake air area 12, centered by the front profile 13, and the central shaft 14, on which is free centered the <<<ONE INTEGRATED>>> endothermic, hyperbaric, adiabatic, stoichiometric turbo fan, turbo compressor 15 with peripheral gas turbine, described in the FIG. 1, provided with multiple crown, of gas turbine stages 16, and a front nozzle guide vanes 17 for the turbine intake combustion gases.

The compressed air/cryogenic oxygen conducted by the channel 18 is activated in a high vortex movement in the central combustion chamber 19, in which the gas turbine fuel/cryogenic hydrogen injectors, including for endothermic liquid hydrogen 20, and the rocket fuel/hydrogen injectors 21, are distributing the combustion energy in their specific direction, including in the final jet exit 25.

The exit gases from gas turbine 16 are retro guided by channel 24, in which can be injected liquid oxygen, vaporized by the residual thermal energy of the exhaust gases from the gas turbine 16 and expanded by final jet exit 25, can produce an concentric endothermic, adiabatic total energy associated complimentary energy recuperative cycle, transferred in the exhaust gases at lowest temperature equal to the intake temperature, creating a total 100% thermal efficiency by the PAUL-CARNOT Endothermic, Hyperbaric, Adiabatic, Stoichiometric, cycle, with zero infrared signature.

The air/cryogenic vaporized oxygen for cooling the gas turbine blades is supplied by concentric channels 28 to the outside environment in the concentric envelope of the engine, creating a total adiabatic general engine. The front profile is a container volumes 29 and 13 of the front body of the intake channel 12, is filled by liquid oxygen from which is distributed in all the places exposed to the heat produced by the friction with the high supersonic and ultra sonic speed of flight.

The heat generated by friction with the air, is absorbed by the endothermic cooling and vaporization of liquid oxygen, generating a huge new vaporized 600 times bigger volume than the liquid oxygen maximizing the total propulsion jet in the channel 25, with the endothermic, and adiabatic recovered energy, equivalent with the electric energy used for production of cryogenic liquid oxygen and hydrogen, creating an associated electric energy for supplementing the combustion energy of the oxygen and hydrogen, creating first time in the history the electrification of the aviation and space propulsion.

The variable geometry rocket control body 22, is controlling by sliding on (a or b) direction opening or closing the rocket jet.

At the maximum speed of the turbo jet regime, when is reaching the limit of the flow capacity of gas turbine to receive the flow from the combustion chamber 19, coincident with the limit of rotation, and from now, is the moment to open the rocket combustion flow, and starting the combustion of all the fuel/liquid cryogenic endothermic vaporized hydrogen of the injectors 21 in the air/cryogenic vaporized oxygen flow, which is coming correspondingly at higher speed, resulting a total endothermic adiabatic maximum absolute efficiency PAUL-CARNOT THERMAL CYCLE, with equal exhaust, and intake, temperature definition of 100% thermal efficiency.

At high altitude or in space, when the density of the air is diminished, or zero, the injection of liquid oxygen 23 endothermic vaporized in the intake can supply in the same area 5 time more cryogenic oxygen, without nitrogen, resulting the maximum absolute power in the thermodynamic to produce a trust from 200-1000/1 trust to weight ration.

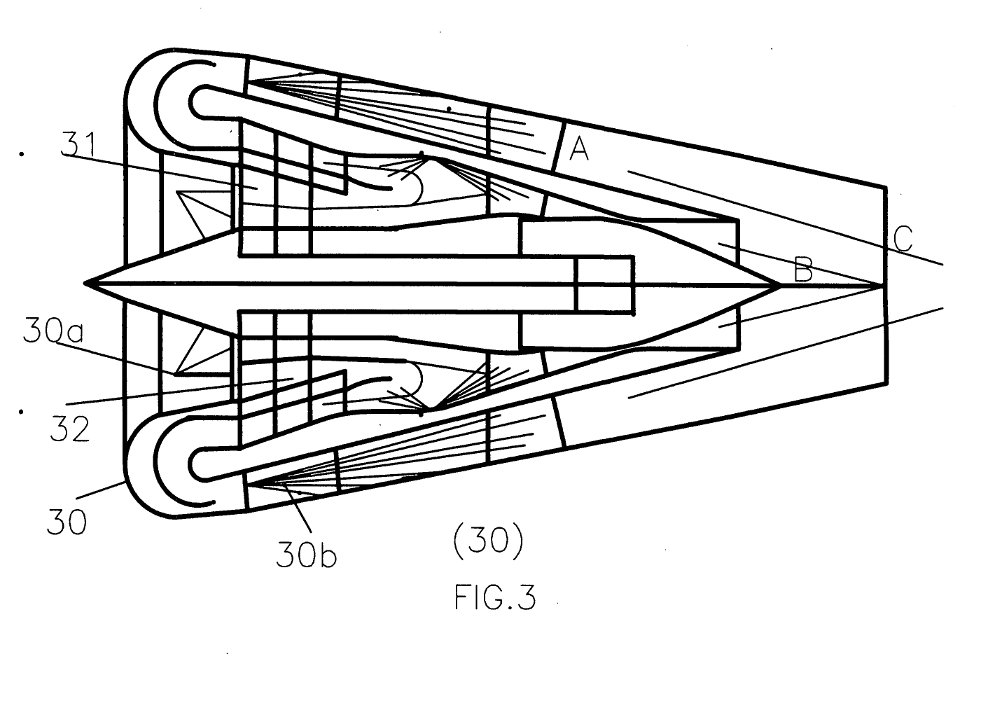

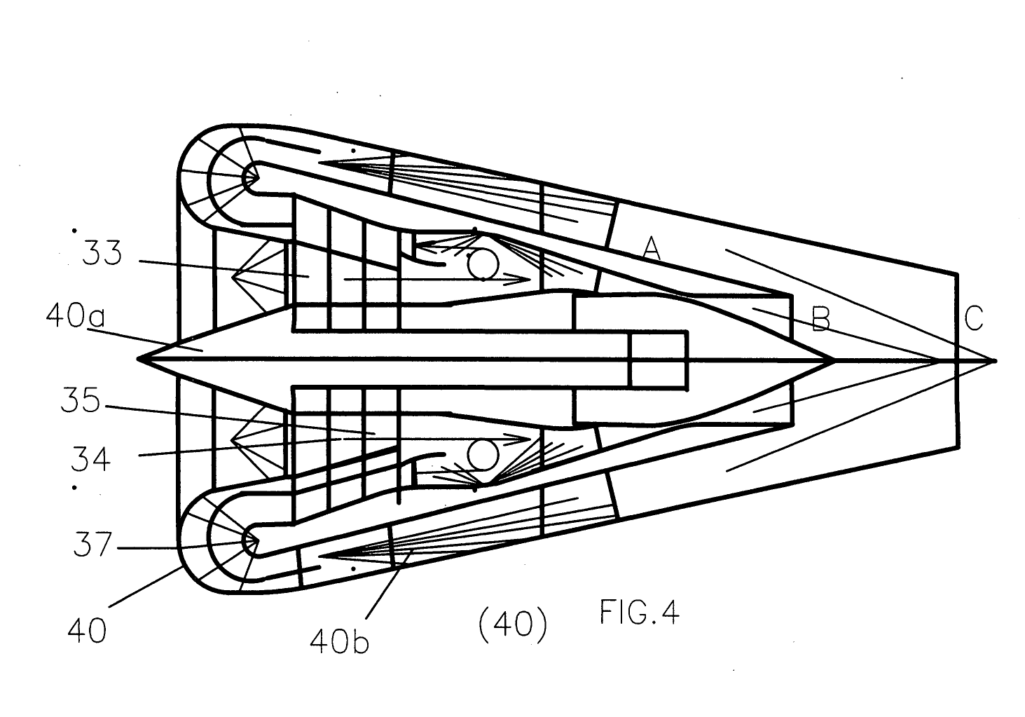

The FIG. 3 and FIG. 4, are described extended concepts of the concept described in the FIG. 2, by using 2, two turbo compressors indicated by the generic number (30), with counter rotating rotors 31 and 32, and in FIG. 4 indicated by the generic number (40), the counter rotating rotors 33,34,35 integrated turbo compressor rotors, with all the same features and characteristics explained in the FIG. 2, with correspondingly higher total compression and expansion ratios, which by definition will produce a higher efficiency from ground to the end of the space.

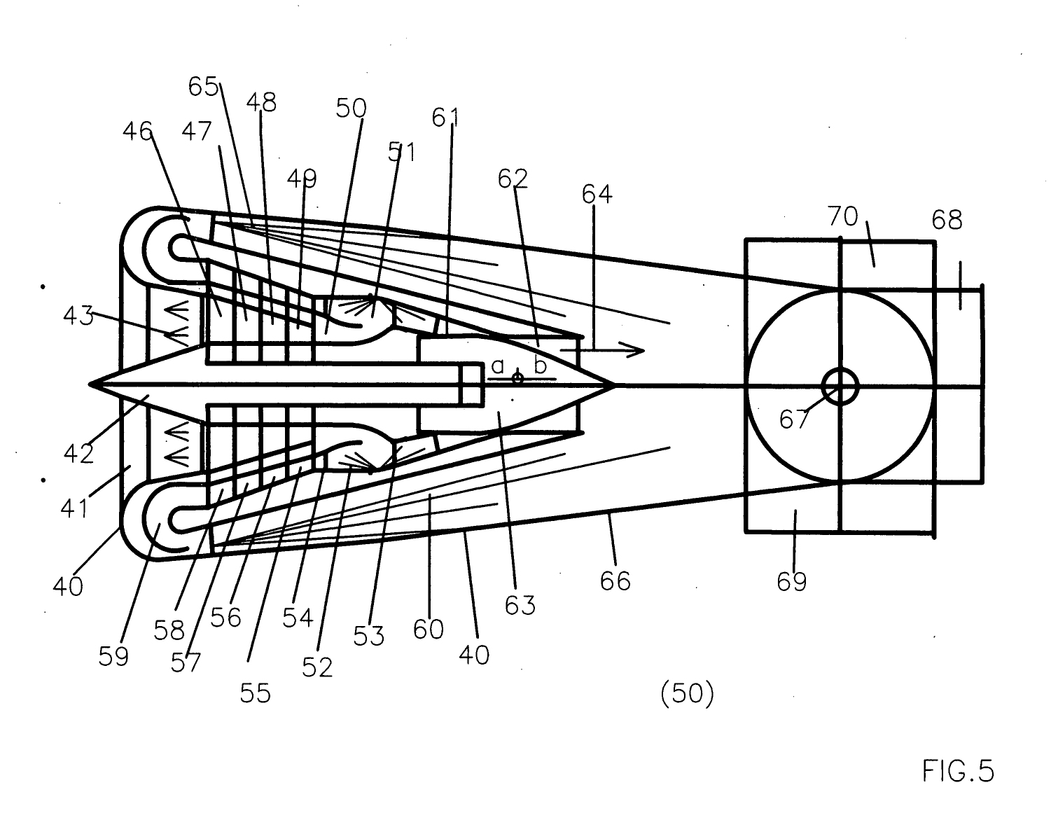

The FIG. 5 is depicted the total application of the fundamental technology originated by the <<<INTEGRATED>>> Turbo Fan, Turbo Compressor with Concentric Peripheral Gas Turbine, described in the FIG. 1, and followed in the FIG. 2, FIG. 3, FIG. 4, culminated by the final recovery of exhaust energy in a complete combined HYPERBARIC PAUL-CARNOT cycle, capable to create ultra high pressure ratios over 300/1, and the association of the universal mobility technology produced by the multi axial vectorial jets propulsion, is the culmination of the end history of the thermodynamic, with absolute maximum efficiency over 80-90%.

The assembled engine is indicated by the generic number (50), and is formed by the general assemble engine 40 having an intake front area 41, a central shaft 42, a front liquid oxygen injectors 43, followed by a group of 4 <<<INTEGRATED>>> turbo compressors, described in the FIG. 1, indicated by numbers 46,47,48, and 49, compressing the air at more than 300/1 pressure ratio in the plenum 50, generating in the combustion chamber 51 an intensive vortex for mixing the fuel injected by injectors 52, and 53, supplying the combustion for the counter rotating group of counter rotating gas turbines 54,55,56,57, 58, and reversing the flow gases by the 59 collector channel, followed by cryogenic liquid oxygen injection, for capturing all the residual energy of the exhaust gases resulted from the gas turbine counter rotating gas turbo rotors and conducting the gases in the expansion jet channel 60.

The final combusted gases 61, produced for the rocket jet 62, is controlled by the variable geometry profile 63, controlling the final rocket jet 62, and 64, by the sliding in the direction (a and b).

The final energy collection and energy recovery, is mixing all the gases, in the adiabatic plenum 66, and transferred in the universal multi vectorial multi axis 67, 68, 69, 70, generating a final absolute maximum efficiency complete and combined PAUL-CARNOT cycle, and universal mobility capability.

At very high altitude and in space the absence of air is replaced by liquid oxygen cryogenic evaporated flow of oxygen supplying 100% oxygen without nitrogen for combustion of liquid hydrogen preliminary used to cool all the body of the engine, in an endothermic process of recovering the cooling energy returned to the combustion for producing the maximum absolute thermodynamic PAUL-CARNOT cycle, power and trust, to the immense level of 200-1000 trust to weight ration to the end of the unlimited universe.

This unique maximum absolute universal supreme hyperbaric thermodynamic technology is the ideal replacement of actual space technology including the solid fuel booster none controllable rockets, which already killed space missions.

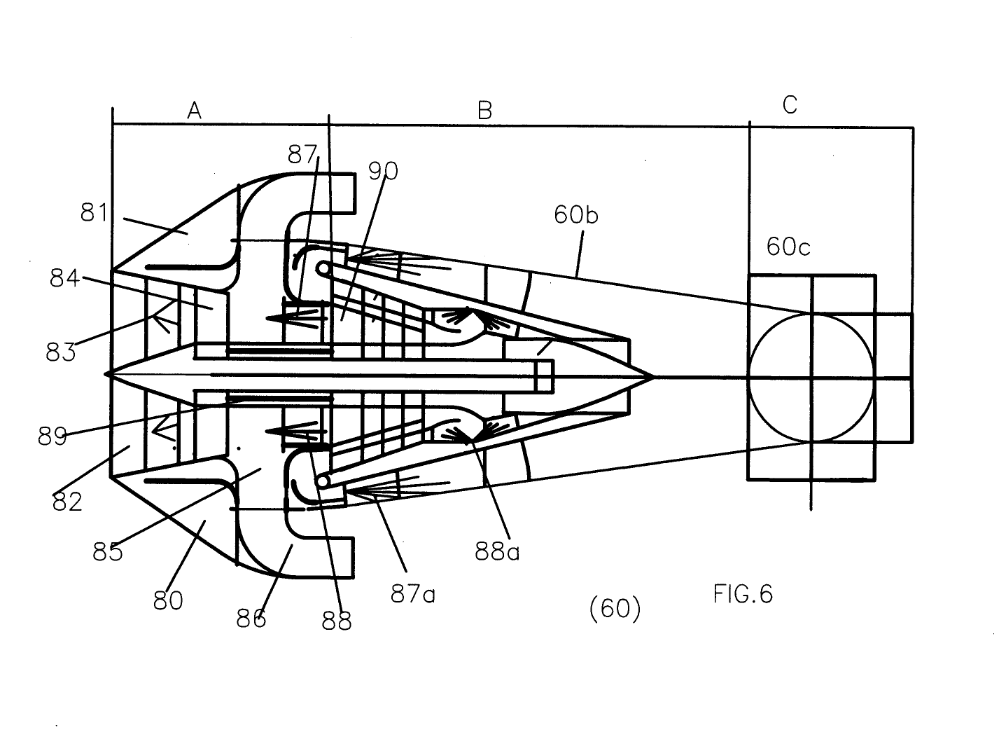

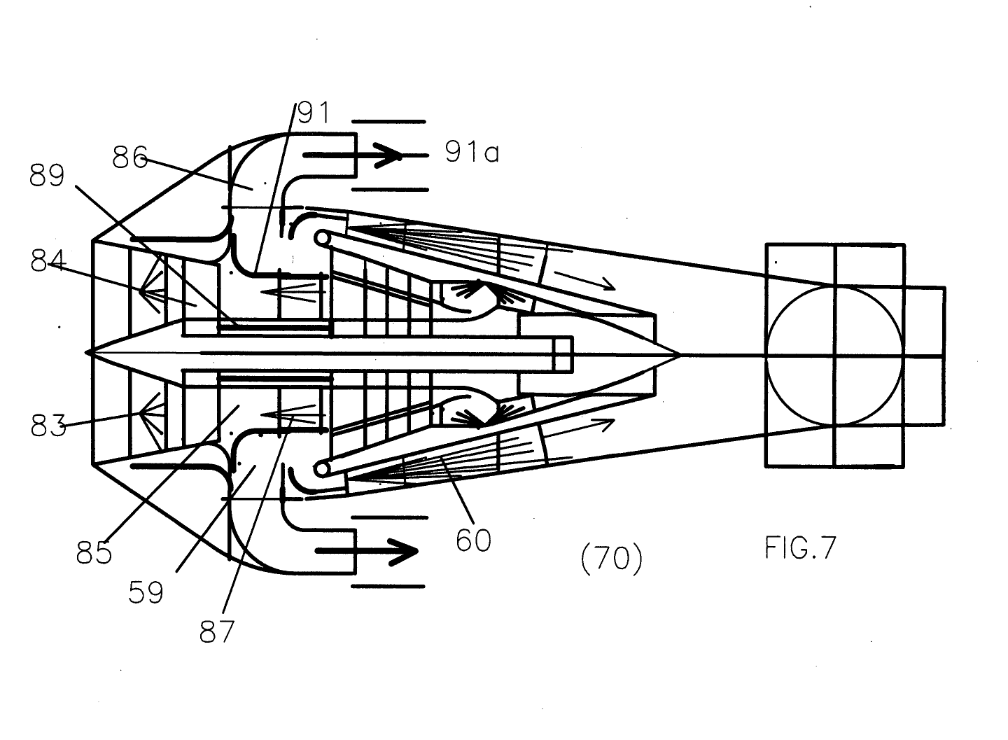

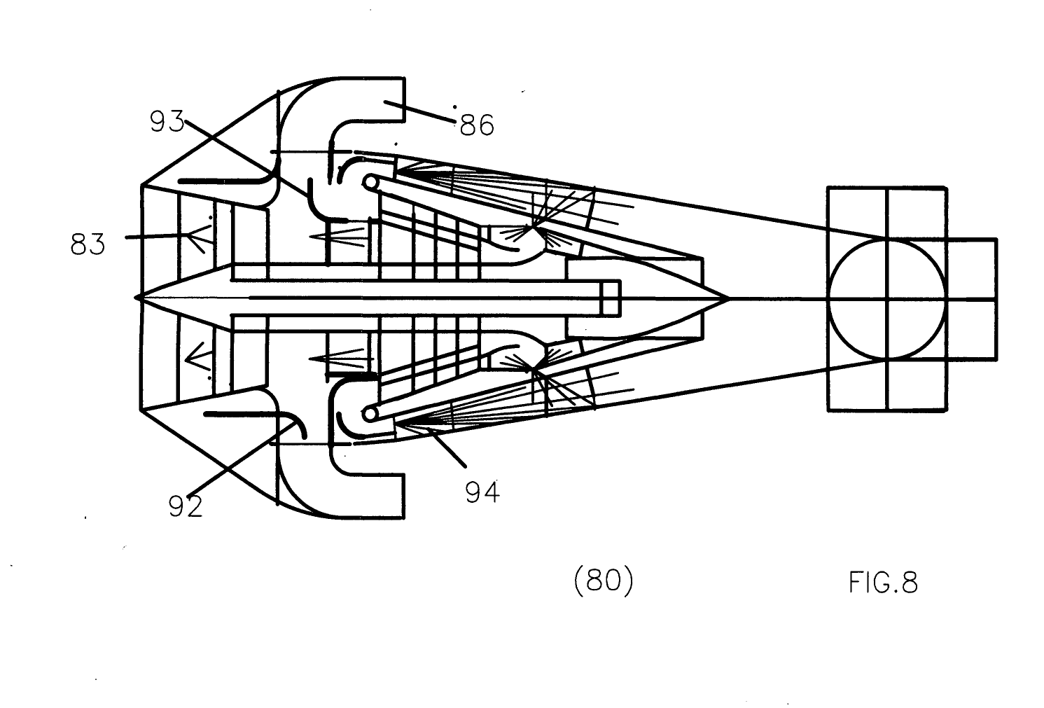

In the FIG. 6, FIG. 7, FIG. 8, are depicted successively and sequentially the three operational and transitional alternatives, of the unique totally cooled core of all exposed components to hot gases, which are endothermic ally recovered in the power of the combined collected exhaust gases, associated with the turbo rocket jet.

All the turbines alternatives of the ONE Universal Mobility Convertible Turbo Fan, Turbojet, Turbo Rocket, are forming a unique family of capability for most versatile multi mission, unique in the history of aviation, of instant and unlimited capacity for changing the action by the unique <<<ONE CONVERTIBLE IN FLYGHT ENGINE>>> and applicable to all conceivable application for all military services, standing in air, hovering over any target, flying on any speed, subsonic, supersonic, all combined three cycles culminating on rocket unlimited speed and altitude to the end of space, launching satellites, including vertical takeoff and landing from any place to any place without air ports or special grounds, including any general naval surface or air craft carriers, thermal stealth with zero infrared signature.

The capacity to start from any ground bases, flying in atmosphere, and continue in space with ultra sonic speed with maximum absolute efficiency, using any fuels, with special interest in cryogenic oxygen and hydrogen to orbit and to the unlimited universal distances, and return back landing in any potential places, is making this family of engines a unique universal mobility system for ever.

This family of engines is provided with two stages injections for liquid oxygen including in front of the fan rotors to activate his operation including in the low density air or absence of air in the space operation.

This ultra versatile family of engines can be the universal replacement of all existing old obsolete low efficient engines, by this absolute maximum efficient engines based on Paul-Carnot cycles, at lowest level of specific fuel consumption having the ability to fly around the globe without refueling in air to any potential targets in shortest time in the history of aviation.

In the FIG. 6 is indicated the first alternative structure and operational Turbo Fan-Air external activated universal direction air jets, in association with internal Turbojets and Turbo Rocket adiabatic mixed flow propulsion gases supplied in the multi axis vectorial final jets, making the engine a universal mobility system, generically composed from three functional modules A,B,C, having the specific functionality A, for turbo fan operation, the module B, for power generation, and module C for universal mobility.

The general composition of this FIG. 6 operational alternative is based on the generic indicative number (60), having a general assembly 80, including the front turbo fan module A 81, having an intake front area 82, and first liquid oxygen injectors 83, and the front fan rotor 84, compressing the air in the plenum 85, and dispersed by universal directional air jets 86, supplying the total air in 50/50 proportion for air jets, and the intake of the core gas turbine compressor 87, in which are provided the second liquid oxygen injectors 88, the tubular concentric shaft 89 is driving the fan 84, connecting the first turbo compressor 90, followed by the group of 3 gas turbine compressors, described in the FIG. 1, and FIG. 5, forming the general core of entire gas turbine assembly described in the previous FIG. 5. followed by the module C, of the multi vectorial axis of universal mobility system 60c.

In the FIG. 7, is indicated the second operational alternative with internal Turbo Fan-Turbojets, and Turbo Rocket, in which all the compressed air is supplied by the front fan 84, and is conducted by the guiding air-gas device 91, creating a concentration of air in the channel 85 conducting all the air in the core of the gas turbine, described in the FIG. 5 and FIG. 6.

The combustion gases resulted from the gas turbines are diverted in two flow one partial flow to the gas exit jets 86, and the rest of the gases following the original exit 59, and 60 described in the FIG. 5.

The second cryogenic oxygen injectors 87 are injecting supplementary liquid oxygen, directly in the core engine for maximization of entire cooling assembly of the engine, and maximizing 5 times the power capacity and trust to weight ratio to 200-1000/1.

The exhaust gases from the counter rotating gas turbines, from exit nozzles 86 are conducted and associated with the air ejectors 91a, in which the supplementary air is diluting and capturing all the residual energy, in a mixed proportion for reducing the final temperature closed with atmospheric level.

In the FIG. 8, is indicated the third operational alternative, in which the sliding air guiding channel 92 if is closing totally the external exit 86 of the air, is guiding all, the air in the core of the engine, creating a totally Turbo Fan, Turbojet, Turbo Rocket triple combined thermal Paul-Carnot cycle with absolute maximum efficiency over 90%, unique engine in the history of aviation.

The liquid cryogenic oxygen 94 is injected in the exhaust gases capturing all the residual energy, and completing the total Paul Carnot cycle with exhaust combined temperature equal with intake temperature, creating the condition for 100% maximum efficiency and zero infrared signature.

In the same FIG. 8, is indicated the transitional operational alternative in which the sliding air device 92, and the sliding gas device 93 are in different level of position controlling separately the air exit in the 86 jet, and the sliding device 92 is diverting variable exit of bypass air in variable proportion with air jets.

All the previous description operational alternatives are combined in different transitional proportions.

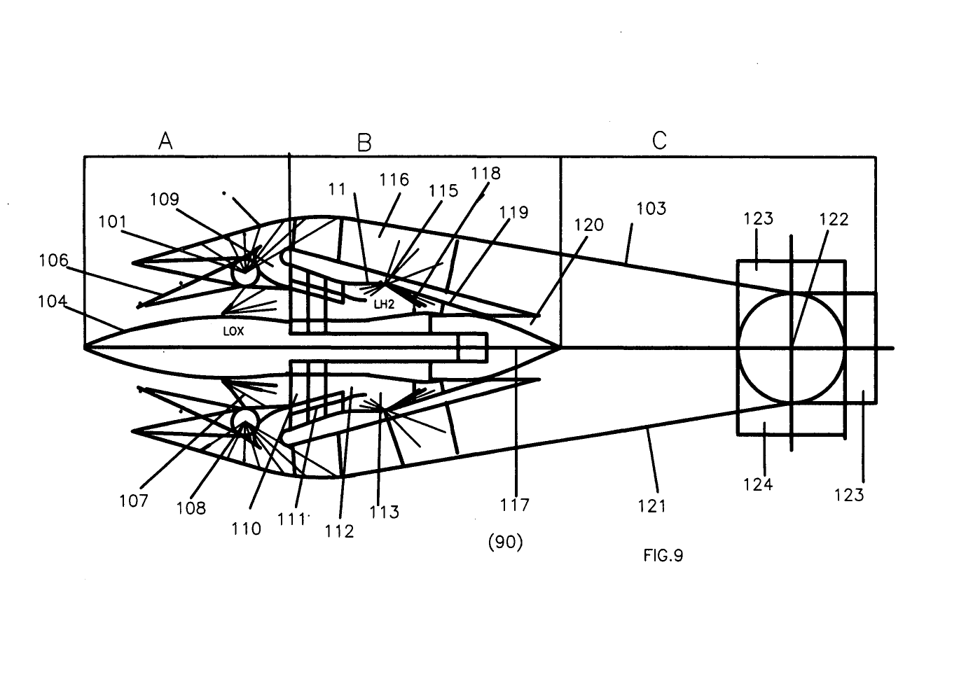

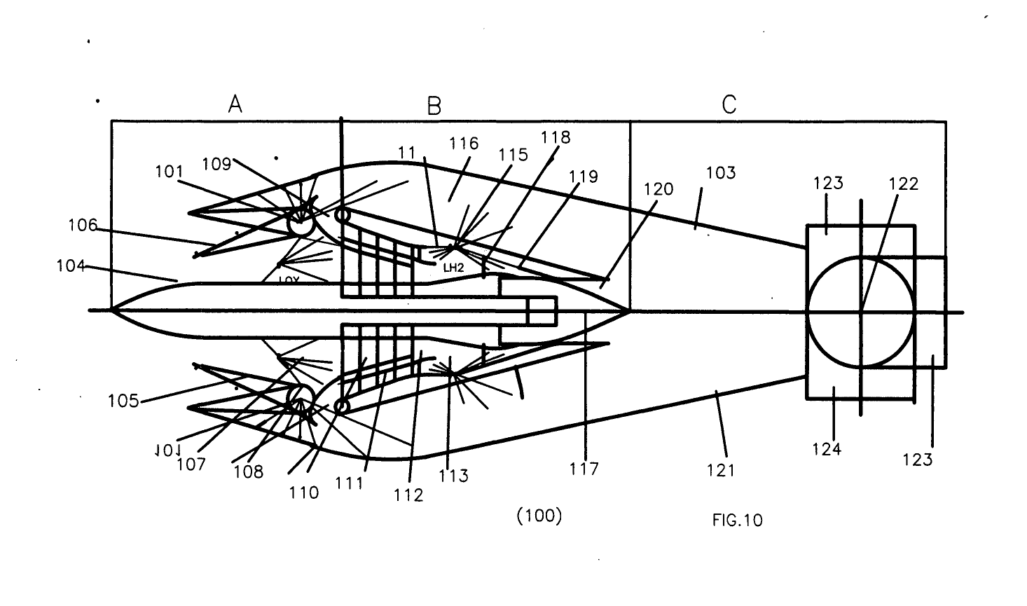

In the FIG. 9, and FIG. 10, is indicated the Universal Convertible with Variable By-Pass Two, and Four Turbojets, Ramjet, Turbo Rocket, capable to operate from lower to ultra high speed, in air and space with endothermic, adiabatic, universal mobility, variable bypass subsonic, supersonic, ramjet and rocket, combined Paul-Carnot cycle, having a totally cooled core central and all external body, adiabatic assemble, including on cryogenic oxygen and hydrogen, ultra high compression and expansion ratio, over 300-400/1, with unique ability to have a continuous operation on each and all combined cycles operation, with variable bypass air intake and ramjet, in association with variable rocket full power operation at stoichiometric maximum absolute power, maximum absolute efficiency, achieving close equality of exhaust temperature with intake temperature, equivalent near 100% efficiency, and zero infrared signature, produced by the universal Paul-Carnot cycle

This family of engines is the maximum absolute and total final end of evolution reaching the absolute revolution of all aviation and space technologies for ever.

The ultra high power density result of 100% stoichiometric for combustion of all the air or oxygen and supreme simplicity, and lowest weight, is conferring to these family of engines an immense trust unimaginable for actual gas turbines to trust to weight ratio 200-1000/1, unique and maximum absolute in the history for ever.

In the FIG. 10, is indicated the composition of this same basic Universal Convertible Variable Bypass Four Turbojets, Ramjet, Turbo Rocket, composed from three modules A, B, C, in which A, represents the front intake module, with variable by pass ratio, creating a large capability for multiple missions, from pure turbojets, ram jets and full rocket maximum power and combined trust propulsion.

Module B represents the Four Turbojets rotors described in the FIG. 1, and FIG. 3, and module C represents the general Universal Mobility Multi axis vectorial jet guided jet flow, of all combusted gases including the rocket jet, mixed and collected in the module C, creating a homogenous cooled final jet for universal mobility flying opportunity.

In The FIG. 9, the composition of module A, is indicated by the number 101, hawing in front the central profile of the variable air bypass intake 104, which is sided by the channels control devices 105 and 106, followed by the liquid oxygen injectors 107, and the rotation articulations 108, and reversing exhaust gas flow 109, in which the injection of cryogenic oxygen, is recovering all the residual energy, by the vaporization of the liquid oxygen an eliminating all the thermal loses in a complimentary ram jet process, equalizing the exhaust temperature with intake temperature, raising the efficiency of PAUL Carnot cycle to near 100%.

The combustion and energy generation module B, is including the group of double or four free counter rotating gas turbo compressor rotors 110 and 111, described in the FIG. 1, and FIG. 3, followed the central air/oxygen compressed plenum 112 and central combustion chamber 113 in which an intensive compressed air/oxygen vortex is sustaining a high quality combustion process, with a group of three fuel injectors 114, 115, and 118, supplying the fuel for the group of gas turbines 110 and 111, and the rocket combustion 119.

The variable geometry rocket control jet is controlled by the central profile device 117, which is opening or closing the exit area of the rocket jet 120.

The expanded combusted gases resulted from the group of counter rotating free gas turbines are reversed by the collecting channel 109, in which can be injected the cryogenic oxygen, for capturing the residual thermal energy from the combusted and expanded gases in the jet channel 116.

The universal endothermic, adiabatic, mobility module C, 121, is the general collector and mixer of all gases which are directed in selected sequential multiple vectorial jets 122,123,124, 125.

The FIG. 10, is the universal conversion with variable bypass in a position of control 106, of all the air flow toward the ramjet peripheral concentric channel 101-116, separating the central flow for totally cryogenic turbojet, and turbo rocket, based on cryogenic 100% oxygen and hydrogen maximum turbojet, and turbo rocket propulsion, which can be supplemented by peripheral concentric ramjet propulsion, activated by the fuel injection 115.

The total combined energy generation will provide the maximum absolute trust and speed in the history of thermodynamic of aviation and space propulsion from ground to the unlimited space and universe.

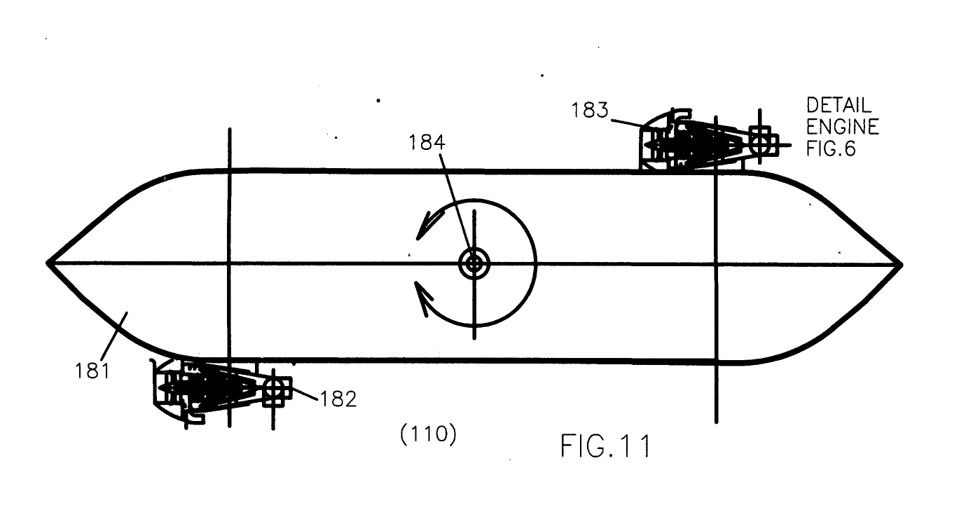

In the FIG. 11, is the Universal Mobility Wingless, Tailless, indicated by the generic number (110) having two universal aero space engines, all of them and each of them alternative engines described in this invention.

The elimination of wings and tails is generating a new class of total revolution universal aviation and space, for a total capability of vertical takeoff and landing, from and to any place, creating a real universal aviation and space, without airports or special ground or naval aircraft carriers

The composition of this vehicle is formed from a flying central fuselage 181, and attaché two independent controlled universal engines, 182, and 183, around the center of gravity of 184 all of them, capable to supply the power and universal multi directional vectorial trust jets, standing in air, flying in any direction with subsonic, supersonic, air and space turbojets, turbo ramjets and turbo rockets, navigating on sea surface, and submarine, jet propulsion with extreme high speed under water, and returned on surface after self generation of oxygen, hydrogen, liquefied and stored.

The vehicle is provided with a new nuclear-electric, hyperbaric generator, supplying the electric energy for the electrolyzing the sea water for production and liquefying, and storing the oxygen and hydrogen, for unlimited navigation, on sea, air and space.

The self generation of oxygen and hydrogen on board, by the nuclear electric hyperbaric generator is equivalent, with nuclear-electrification of navy, aviation and space at highest efficiency of Paul-Carnot supreme cycle, closed to maximum absolute 100% efficiency, and unlimited universal travel forever.

This universal technology is eliminating the fissile fuels and the solid fuel rocket booster, unreliable and killer of our astronautic team.

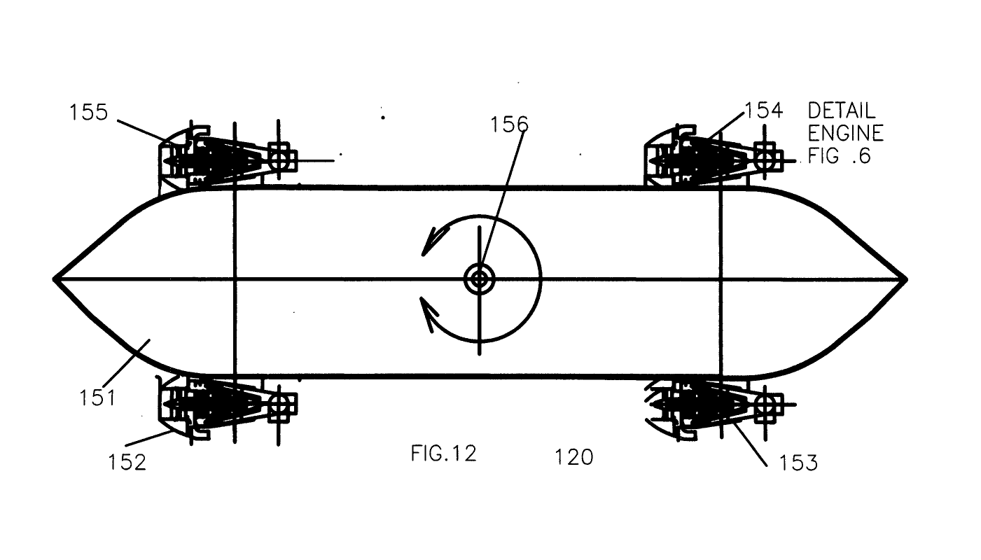

In the FIG. 12 is indicated the Universal Mobility Wingless, Tailless Convertible, Endothermic, Adiabatic, Multi Turbojets, Ramjets, Turbo Rockets, vehicle, indicated by the generic number (120).

This is a Real Universal vehicle for all and General Unlimited Mobility Systems and missions, in all forms of existing universal mediums, air, sea and space, and for all military, and commercial, application in the world, composed from a central fuselage 151, and multiple symmetric distributed Universal Aero Space Engines 152, 153, 154,155, around of the center of gravity 156, object of this invention, forming an unlimited unique new revolutionary class of Universal Aviation, Naval, and Space Vehicles, for unlimited and eternal world applications on air sea, and the end of space.

The elimination of the wings, and tails, is reducing dramatically the military vulnerability, by reducing the size of the visible exposed target dimension, the smallest radar signature, and the capability for absolute mobility, stability, flying and reduced drag loses, hovering and standing over any target, instantly turning around the center of gravity 155, in any directions, including back and or up and down, from any place to any place, vertical taking off from any place or ground, unlimited flying to any place and landing to any place, on minimum platforms, without airports, and overall places or targets.

The special ability to start and take off from any size of general ships any time is an invaluable amplification of the military aero naval and space launching cruise missile and intercontinental ballistic missile around the globe and an instant independent aero naval capacity to be a total global force.

The ability to form a universal commercial aviation without air ports is the biggest revolution of entire human civilization.

This family of universal flying vehicles can be of enormous size and loads, including flying nuclear power plants, producing power and pure water from sea, or any contaminated water, in deserts, mountains, transporting troops, armored vehicles, cruise missiles, creating intercontinental large missiles, creating instant military bases, for special forces, moving and hovering over any targets, at very high altitude, carrying powerful laser guns for attacking from space any target, generating a supreme mobility general weapon.

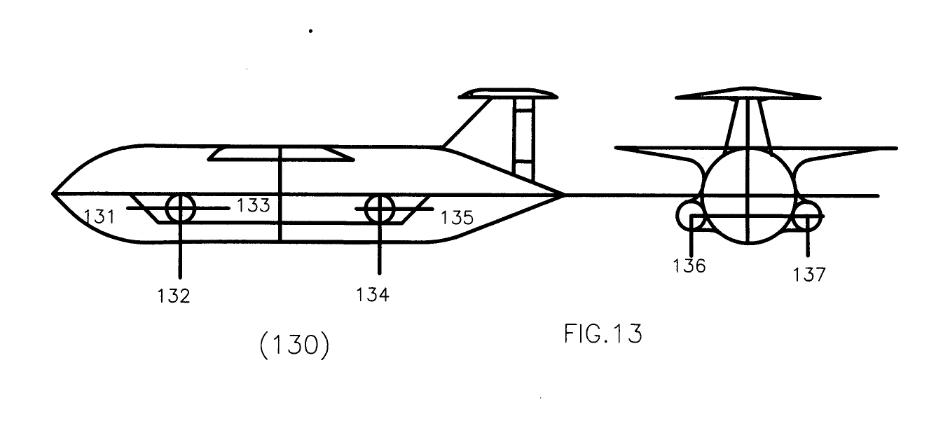

In the FIG. 13, is indicated a generic example for general capability to use all the engines described on this invention, using these previous Universal Convertible Mobility solutions by the FIGS. 1 to 12A for revolutionary conversion of all conventional military and commercial existing actual aviation.

The attachment of supplementary engines described in the FIGS. 1 to 12A, to the existing air planes, can transform, all the actual aviation in Universal Mobility systems, covering all the planet, creating an universal connection of all places with all places in the world, without airports, including the most remote dispersed localities in the actual world, totally Isolated undeveloped countries on this planet.

This can be the major historical revolution in all the humanity to extend the civilization on the entire planet forever.

In this FIG. 13, is indicated a generic airplane 130, on which can be attached universal mobility groups of engines previous described and objects of this invention, to provide all the potentially directions for operations, 131, 132, 133, 134, 135,136,137.

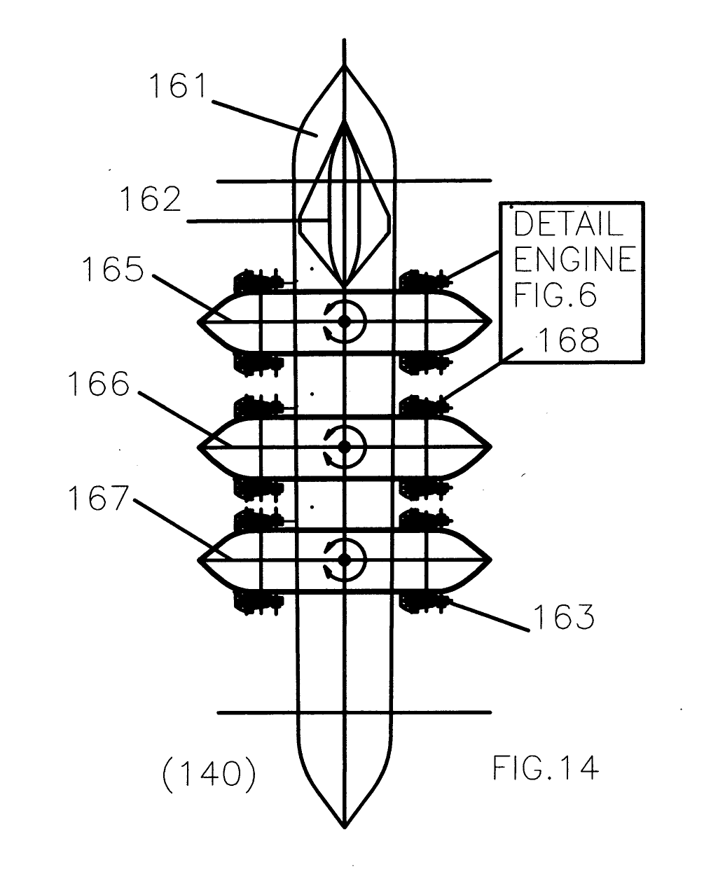

In the FIG. 14, is depicted by generic number (140), the Universal Mobility Wingless-Tailless, endothermic, adiabatic, Multi Turbojets, Ramjets, Turbo Rockets, organized transversal over the runway of the aircraft carrier 161, on which is indicated a small air plane 162, which is using the entire surface to take off and landing, by one and each successive air planes, to be in air and on return the same individual landing along all the length of the naval longitudinal dimensions.

In an emergency attack the length of time for taking off entire protective aero naval fleet, can cost the life of entire naval group with limited capability to have instant participation for all aviation protection.

Displaying transversal all our universal mobility wingless and tailless, 163, to 168, or more, the entire aero naval fleet can start vertical flight instantly, or from both side of the aircraft carrier, with the exhaust jets outside and directly in the sea.

Even at the return back of the aero fleet, all of them can, land shortly on the surface of the aircraft carrier, on very compact arrangement, or simply landing over sea surface or submarinize, with 100% protection.

The aero naval unit is supplied with cryogenic oxygen and hydrogen from the nuclear electric power of the nuclear aircraft carrier owner of nuclear electric main generation, or from each individual nuclear electric power generator of the universal wingless aviation.

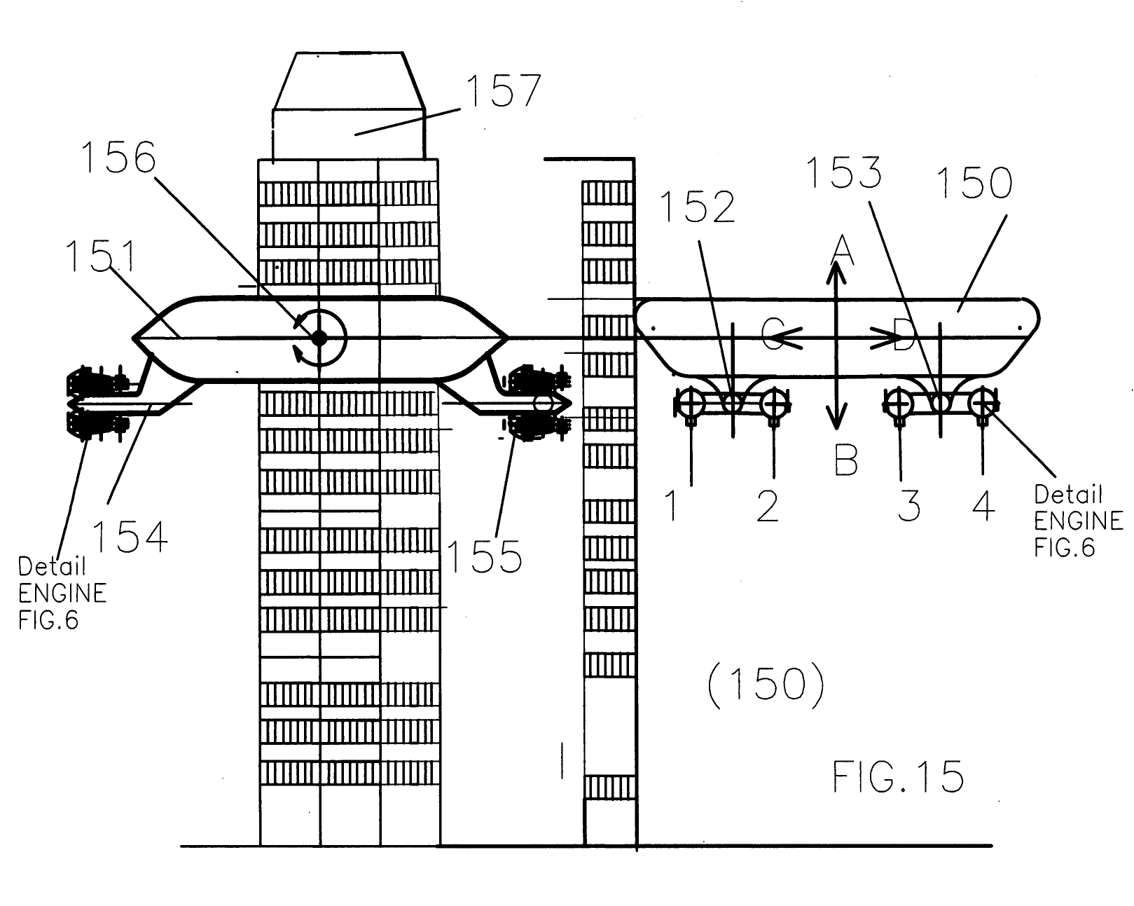

FIG. 15 is the Universal Mobility Fire Fighter Wingless-Tailless, Multiple endothermic, adiabatic, Turbojets, Turbo Rocket, is Indicated by the generic number (150) is the supreme and ideal first flying vehicle to fight against fire at any high level, attacking the fire like the disaster of 9/11, in which the actual fire fighters were unable to reach the fire at many 100's of floors, climbing up on stares, against the thousands of peoples coming down, colliding and blocking them self their salvation.

Our universal mobility vehicle is able to fly and touch instantly outside the walls, avoiding stairs, to the floor with fire, saving people, and instantly stopping and freezing by suffocating the fire by liquid nitrogen, or other special substances.

The universal fire fighter, is made from a flying platform, indicated on two projected configuration 150 AND 151, provided with groups of any option of our universal mobility gas turbines 152, and 153, 154 and 155 object of this invention, distributed to form four sustaining forces with total stability around the both center of gravity 156, and 157, creating a multi directional cross stability and mobility by the forces of axis A, B, C, D.

This invention have an instant capability to touch by all the sides of our universal flying platform, is making this invention a unique in the history a general savior and protector against all potential attacks from internal and external enemies.

This invention is ideal for general accessibility by flying at very high altitude and with high speed, over helicopters, totally protected by zero infrared of all military and commercial transportation of very large and heavy loads by our universal mobility armored aviation, gun ship, to all the remote locations without land communication in special high mountains, deep valleys, deserts, flooded arias, navigation on surface and submarine, and universal flying carriers of troops, entire army and special forces and heavy armored vehicles, artillery and rocket launchers, super power laser canon and universal mobility for rapid deployment and forming military bases on any place on this planet, and total protection against improvised explosive devices.

This invention can be an ideal instantly universal nuclear mobility electric power plant, and generator of oxygen and hydrogen from any sources of sea or contaminated water, generating electricity, and pure water in any place in the world.

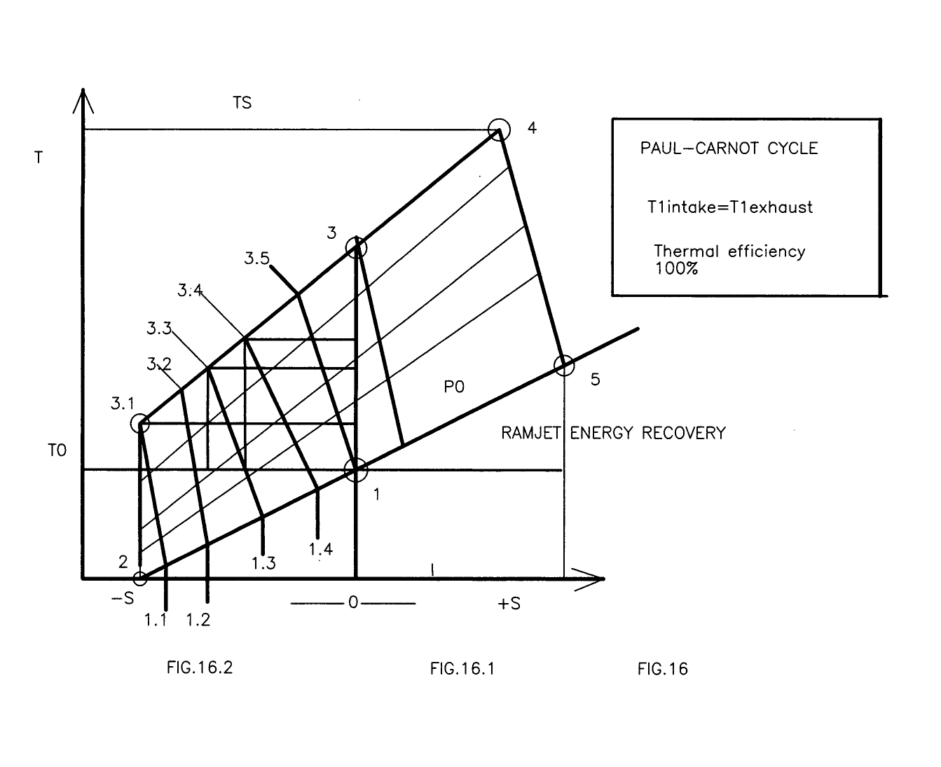

FIG. 16, is indicated the Universal Paul-Carnot Endothermic, Hyperbaric, Adiabatic Cycle, by the generic number (160), In thermodynamic diagram T-S, with total field from (1) atmospheric (T1/P1), to −CRYOGENIC temperature of vaporization of liquid oxygen is at −297.3 F, on negative (−) entropy point (2), followed by an adiabatic compression to pint (3.1), which can be of 300 bar pressure, from which will be a isobar (constant pressure) combustion, until point (3), correspondingly to the original entropy of point (1), and adiabatic expansion between (3) to (1), resulting a 100% efficiency negative entropy cycle.

If will be a continuation of constant pressure combustion to the maximum absolute stoichiometric temperature TS(4), followed by a polytropic expansion point (5), followed by an air/cryogenic oxygen bottom cycle recovery of residual energy correspondingly from the point (5), to original point (1), will be produced the maximum absolute power cycle at maximum absolute efficiency of 100%, is the definition of the Universal Paul-Carnot, Endothermic, Hyperbaric, Adiabatic Thermal Cycle, capable to be the base of all Universal Aero Space Engines created by this invention, which is the top maximum absolute eternal revolution of entire thermodynamic.

What is claimed:

1. The creation of the universal integrated unique supreme technology for all of universal forms of transportation from ground to the space end of the universe, by one and multiple classes of engine for aviation, naval, and space, engines and vehicles, technology, is based on a one universal, and common, combined and integrated one supreme universal gas turbine with one peripheral crown rotor, concentric with a central axial and or centrifugal, or compressor rotors, creating the base for a supreme unlimited families of gas turbines, turbofans, turbojets, turbo rockets, and turbo ramjets, having the capability to achieve a fundamental absolute maximum efficiency integrated universal engine technology, total endothermic, hyperbaric, adiabatic, and stoichiometric creating a maximum absolute power capacity, with unlimited pressure ratios, which is the common base for unification of the way to produce the top absolute maximum efficiency, universal mobility engines, by the combined action of stored cryogenic electric energy for electrification of the entire and universal transportation systems, from ground to the space endless of universe with, additional total electric energy contribution by cryogenic combustion of any and all fuels, and the creation, by the <<<one totally recuperative air and cryogenic cooled rotor and/or groups, of counter rotating gas turbines rotors, with one body or a group of counter rotating compressor rotors, concentric with a central of axial or centrifugal disk of compressors>>> forming a complete one solid integrated one gas turbine and concentric compressor, axial and or centrifugal, creating the common base for a totally integrated family of internally and externally totally heat recuperative, adiabatic cooled gas turbines, turbo jets, turbo rockets, turbo ram jets, for supreme universal mobility of universal propulsion systems families, starting from ground aviation, naval and space vehicles eternal technology, with totally endothermic, hyperbaric, adiabatic, stoichiometric cooled and energy recuperative action for transferring captured heat from all components exposed to hot operation, for and to totally energizing the propulsion jet of the entire central and peripheral body, of the complete engine, with variable bypass ratio, and variable turbo rocket, and turbo ramjet, having combined <<<equal jet exit temperature, with intake air/oxygen temperature>>>, zero infrared signature, and total maximum absolute efficiency, near 100%, which is the definition of Supreme Paul-Carnot Maximum Absolute Efficiency Cycle, for all new and supreme universal engines and vehicles, created by this invention and the wingless and tailless universal mobility, air, naval, surface, submarine, and space, fire fighters of manned and or unmanned vehicle.

2. The creation, of the essential conceptual unique base for the fundamental technology of the rotor core of all this family of engines of this invention, from claim 1, forming a combined rotor of peripheral concentric gas turbine, with one integrated concentric central axial and or centrifugal compressor, self cooled, by the central axial and/or centrifugal flow of air or liquid oxygen, cooled by intake air or cryogenic liquid oxygen ventilation, of the entire rotor by conduction, convection, internal and external film cooling ventilation by micro holes of the hollowed gas turbine blades, provided with fuel or cryogenic injection of liquid oxygen and or hydrogen, absorbing all the cooling heat of the concentric peripheral gas turbine circle of the blades of gas turbines, by axial and centrifugal air or cryogenic oxygen and combined or separate hydrogen injection, producing a peripheral interstage isothermal combustion and expansion, by the endothermic heatcooling recovery and transferred to the central compressed air/oxygen flow for and final jet propulsion.

3. The creation of a new universal class of unique family of engines, of claim 1, is forming a base for alternative engines with one, two, three or multiple counter rotating rotors, of gas turbines and integrated concentric axial or centrifugal compressors, creating a new generation turbo jets, turbo rockets, and turbo ram jets, endothermic, adiabatic, hyperbaric, stoichiometric, associated with concentric hyperbaric high pressure ratios compressors, and crown peripheral gas turbine expansion ratios with cryogenic, endothermic, concentric, and parallel cycles internal and external, for cooling and absorbing the heat from all the exposed hot components, creating the condition for totally endothermic, adiabatic, stoichiometric maximum absolute power, and equalizing the intake temperature with the exhaust temperature, which is the definition of unique characteristic of the Supreme Paul-Carnot cycle, for maximum absolute efficiency closed to 100%, with zero infrared signature and universal mobility multi vectorial system of operation, for subsonic, supersonic, air and space cryogenic turbojets, turbo rocket and turbo ram jets, unlimited flight, to the end of the universe.

4. The invention of claim 1, of the creation and generating a new unique class of families of engines, of turbo fans, turbo jets, and turbo ram jets, in three sequentially, successively convertible in flight, by operating transitional alternatives, endothermic hyperbaric, adiabatic and stoichiometric of the unique totally cooled core by air and/or injected cryogenic liquid oxygen in the front of the gas turbines, turbo jets and turbo rockets, and ram jets of associated in parallel, concentric, external infection of cryogenic liquid oxygen and later liquid hydrogen for total energy full maximum absolute space propulsion, is creating additional energy contribution of optional recuperative residual thermal energy exit from the gas turbines expansion, starting from ground, to the space endless universe, by the capability of universal convertibility in flight, the operation of the engine capability for unlimited missions, by universal mobility flight, for taking off vertically, from any place, to landing vertically in any place without airports, from standing over any place, and flying subsonic, supersonic, turbo rocket, and turbo ram jet, in any direction, instantly reversing the flight direction 360 degree, from ground to the unlimited space of the universe, and landing vertical in any place, any time, without restriction, by a turbofan multi directional air jets, combined with multi directional gas turbine, and turbo rocket jets, and by the multi vectorial combined jets, on air, naval surface, submarine, and the unlimited space of the universe, using total cryogenic associated parallel, internal core cooling and external parallel cryogenic liquid oxygen injection of concentric additional contribution propulsion recuperative thermal and electric energy cycle from the residual thermal energy, resulted from expansion gases of the gas turbine by cryogenic injection of liquid oxygen, and hydrogen, creating an associated endothermic recuperative electric energy, cryogenically stored, producing a supplementary additional energy to the combustion energy cycle, resulting a total endothermic, adiabatic, hyperbaric, stoichiometric cycle for creation of the <<<total equality of exhaust temperature with intake temperature>>> with zero infra red signature, and achieving maximum absolute efficiency near 100%, of Supreme Paul-Carnot cycle.

5. The creation of the supreme family of new class of unique engines with transitional operation capability, from claim 1, having the universal convertible, variable bypass ratio, in flight, to accomplish any and all type of mission, from ground to orbit of the gas turbines for aviation, navy surface, submarine jet propulsion, to the endless of universe using all the eternal energy sources of wind, solar, hydraulic, including nuclear electric energy for production and storing of electric energy in the cryogenic liquid oxygen and liquid hydrogen, produced by the surface ships and submarines, using the universal capability and unrestricted variable in flight the frontal bypass selective ratios, and successive, or combined operation, of turbo jets,
and of unrestricted additional, and optional variable turbo rockets, turbo ramjets and finally totally combined energy of all jets, by totally endothermic, hyperbaric, and stoichiometric combustion, for maximum absolute power and unlimited speed and trust to weight ratios T/WR of immense unimaginable level of 200-1000/1, with absolute unique capability of the engines of this invention for replacing the engines of the space shuttle, solid fuel rocket boosters, with universal mobility multi axis vectorial total combined jets, creating the capability of multi million lb trust for vertical take off and vertical landing, from any place to vertical landing in any place, including satellites, and for general aviation flying subsonic, supersonic, turbo jets, turbo rockets, ram jets, individually or combined with all multi cycles capability, with additional contribution of electric energy stored by cryogenic liquid oxygen and liquid hydrogen, created from any electric generation from eternal sources of wind, solar, hydraulic and nuclear, produced on ground bases, navy surface ships, submarines, having a unique totally air and cryogenic entire engine cooling by liquid oxygen of all the exposed components, of internal and peripherically external of body, with high friction of atmospheric supersonic and ultrasonic, ram jets and gas turbine turbo rockets speed, until exit in space flight to the endless universe, final result of the combined electrification, and thermal energy of cryogenic oxygen and hydrogen, and the creation of equal gas jet temperature, with intake temperature, aero infrared signature, defining the condition of 100% efficiency, result of the Supreme Paul-Carnot maximum absolute efficiency cycle, and supreme capability of eternal global aviation, naval, and space travel.

6. The creation of all these aero space engines, from claim 1, object of this invention, is opening an immense opportunity to replace all of the low efficiency engines, from all existing military and commercial aviation and space, by all these new ultra maximum absolute efficient engines of this invention, producing an immediate revolution of all aviation and space transportation, and the creation of universal mobility aviation to cover all the globe, without airports, and connecting all the humanity.

7. The creation of the unique universal wingless and tailless aviation, is a unique universal necessity for solving the total crisis of aviation many bankrupt by high fuel price, over crowded, jammed airports, and available only in developed countries, and unavailable for 3-5 billion undeveloped nations, without any forms of modern transportations, on ground, air, naval, completely isolated and powerless areas, and millions localities economic statuses, by using the immense power and trust capability, of all the aero space engines created by this invention, is the answer for creating a new era of totally new and universal mobility vehicles for aviation, navy and space, and universal mobility power plants, within universal capability to use any fuels available, in any places, including nuclear energy, for instant energy and pure water generation, for emergency applications, in any place without any ground communications, over the mountains, deep valleys, deserts, flooded area, and fire devastated places and impossible high level of tall buildings, in all the big urban localities, in which the fire fighter are notable to solve disasters like 9/11 terrorist attack actually virtually vulnerable, without any high altitude fire fighter capability by this universa; mobility capability of the wingless, tailless unlimited cooperation with naval operation, from aircraft carriers, with the universal vertical take off and landing, and transversal storage of our wingless, tailless universal mobility vehicles, able to start all the naval fleet instantly, without to wait the actual successive take off and landing horizontal long time operation, many time time source of disasters, which is completely solved by this invention of the universal mobility fire fighter platform capable to attack the fire at any level of the tall buildings, capable to touch the face of the building at the face and the floor of the fire, acting the fire instantly, and salvation of all the peoples from any level.

8. The creation of the Supreme UNIVERSAL Paul-Carnot Maximum, Absolute Efficiency Cycle is the fundamental base of all creations, including all the thermodynamic cominium, from the minus absolute, boiling liquid oxygen of −300 f to maximum absolute stoichiometric temperature for air and or pure oxygen combustion of all fuels including hydrogen, using the new Universal Aero-Space engines. And all naval applications, and Universal Mobility Aviation, is the fundamental eternal solution entire humanity, starting with atmospheric Point (1)
P1,T1 of zero entropy, followed by a constant pressure liquid oxygen injection in the intake, until full reduction of the temperature to the boiling temperature of the liquid oxygen (−300 f)
Point 2, followed by an adiabatic compression until maximum absolute pressure (3.1), proper for the structure of the engine, followed by a constant pressure combustion to the maximum temperature (3), correspondingly with the adiabatic point 91) of zero entropy, and by optional decision to start an adiabatic expansion to the point (1).
All THIS NEGATIVE ENTROPY CYCLE IS REACHING 100% efficiency, by starting from point 1 and finishing at point 1.
For maximum absolute power generated by stoichiometric combustion temperature TS, at constant pressure, to the maximum TS, point 4, will followed by an adiabatic-polytropic expansion to the point (5) to the final atmospheric pressure, now by, injection liquid oxygen in the exhaust gases, will start an recuperative bottoming cycle for capture all the residual energy of the point (5) to final point (1), with 100% efficiency.
All these three cycles, of negative entropy 100% efficiency and the additional positive entropy cycle, with additional bottoming recuperative cycle is also 100% efficient, by closing all the cycles to the original starting point (1), resulting the maximum absolute total power and maximum absolute 100% efficiency and zero infrared signature.
